(19) United States
(12) Patent Application Publication
(10) Pub. No.: US 2009/0316294 A1
(43) Pub. Date: Dec. 24, 2009

(54) HEAD POSITIONING CONTROL METHOD, MAGNETIC DISK APPARATUS AND FEEDBACK CONTROL METHOD

(75) Inventor: Masafumi IWASHIRO, Ome-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/551,233

(22) Filed: Aug. 31, 2009

Related U.S. Application Data
(63) Continuation of application No. PCT/JP2008/053492, filed on Feb. 28, 2008.

(30) Foreign Application Priority Data
Oct. 24, 2008 (JP) 2008-274691

(51) Int. Cl. G11B 21/02

(52) U.S. Cl. 360/75; G9B/21.003

(57) ABSTRACT

According to one embodiment, a head positioning control method comprises suppressing a first frequency component and increasing a second frequency component of a control signal for moving a head to a desired position over a magnetic disk, and moving the head to the desired position over the magnetic disk by an actuator based on the control signal.

### CROSS-REFERENCE TO RELATED APPLICATIONS

This application is based upon and claims the benefit of priority from Japanese Patent Application No. 2008-274691, filed Oct. 24, 2008, the entire contents of which are incorporated herein by reference.

### BACKGROUND

1. Field

One embodiment of the invention relates to a head positioning control method for a magnetic disk apparatus.

2. Description of the Related Art

A multi-rate system is a digital control system in which signals having different frequencies coexist, and provides a control technique to improve control performance under a condition that an observation period cannot be set arbitrarily.

On a disk of the magnetic disk apparatus, position signals are written at certain intervals. A position of a head is obtained by reading the position signals. An observation period of the position signals is determined based on the number of the position signals written on the disk and a rotational speed of the disk; therefore, the observation period cannot be set arbitrarily. On the other hand, a period of control input for controlling head positioning can be set faster depending on performance of a control processor or a digital-to-analog converter. Thus, the head positioning control system for the magnetic disk apparatus can be configured as a multi-rate control system where an observation period of the position signals is different from a period of the control input.

When a mechanical resonant period of a control target is higher than a Nyquist period, the control input may excite a mechanical resonance mode. A multi-rate control system disclosed in pages 129-130 and 268-269 of “Nanoscale servo control (first edition)” written by, T. Yamaguchi, M. Hirata, and H. Fujimoto published by Tokyo Denki University Press on Oct. 20, 2007, utilizes a digital filter operating at a frequency which is N times (N is an integer equal to or larger than 2) of a sampling frequency of position signals to eliminate frequency components near a resonant frequency from the control input.

This conventional magnetic disk apparatus eliminates frequency components near the resonant frequency from the control input by the digital filter. Therefore, the frequency component of the resonant frequency from the control input is not applied to the control target, and the mechanical resonant is suppressed. However, when the digital filter reduces a gain at the resonant frequency, phases in a lower frequency band delay to deteriorate the phase characteristic.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary view showing a configuration of a servo control system for a magnetic disk apparatus, according to an embodiment of the invention;

FIG. 2 is an exemplary block diagram of a multi-rate feedback control system, according to an embodiment of the invention;

FIG. 3A is an exemplary Bode diagram showing gains of a resonance suppression filter and a resonance filter, according to an embodiment of the invention;

FIG. 3B is an exemplary Bode diagram showing phases of a resonance suppression filter and a resonance filter, according to an embodiment of the invention;

FIG. 4 is an exemplary Nyquist diagram of the multi-rate feedback control system, according to an embodiment of the invention;

FIG. 5A is an exemplary view showing gains of open loop transfer functions in the multi-rate feedback control system, according to an embodiment of the invention; and

FIG. 5B is an exemplary view showing phases of open loop transfer functions in the multi-rate feedback control system, according to an embodiment of the invention.

### DETAILED DESCRIPTION

Various embodiments according to the invention will be described hereinafter with reference to the accompanying drawings. In general, according to one embodiment of the invention, a head positioning control method for a magnetic disk apparatus comprises suppressing a first frequency component and increasing a second frequency component of a control signal for moving a head to a desired position over a magnetic disk, and moving the head to the desired position over the magnetic disk by an actuator based on the control signal.

Hereinafter, an embodiment of a magnetic disk apparatus according to the present invention will be described with reference to the accompanying drawings.

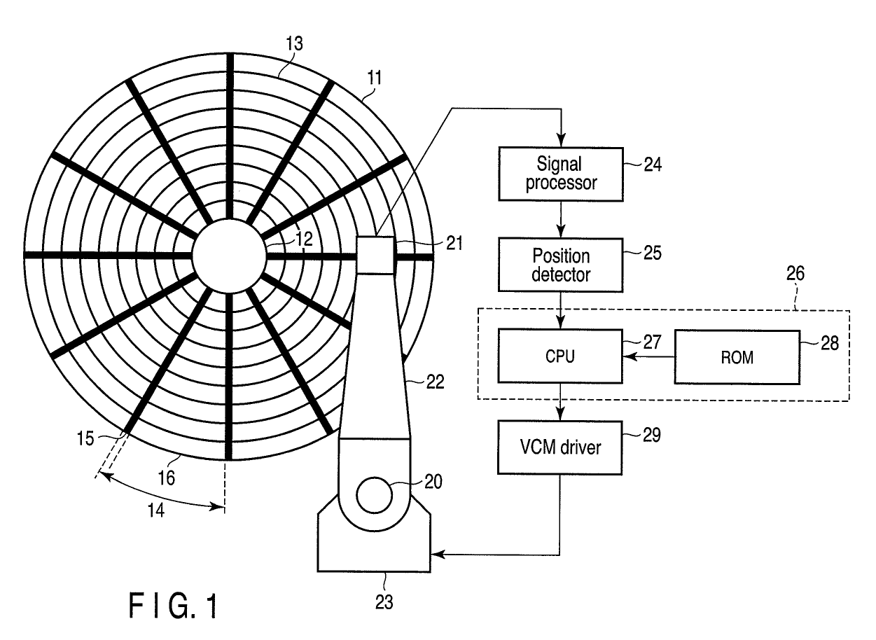

FIG. 1 is an exemplary view showing a configuration of a servo control system for the magnetic disk apparatus, according to an embodiment of the invention.

The magnetic disk apparatus comprises one or more magnetic disks 11. The magnetic disks 11 are attached to a spindle motor 12 which rotates the magnetic disks 11. Variety of data is written into the disk 11.

On a surface of each of the disks 11, tracks 13 are concentrically formed centering on a rotation axis of the disk. The disk 11 is simplified for purpose of illustration in FIG. 1, however in practice, tens or hundreds of thousands of tracks 13 are formed on the disk 11. Data will be written on the tracks 13.

Each of the tracks 13 includes servo sectors 14, which equally divide the track 13 in a circumferential direction. Data write is performed per servo sector 14. Each of the servo sectors 14 includes a servo area 15 and a data area 16.

The servo area 15 is located at the head of the servo sector 14. In FIG. 1, servo areas 15 are radially disposed on the disk 11 for purpose of illustration. However, the servo area 15 may be in a circular shape curving along a locus of a head 21. In the servo area 15, servo data is written for detection of a position of the head 21. The servo data includes a magnetic pattern called “servo pattern”. The data area 16 stores a certain amount of user data.

The head 21 reads the servo data stored in the servo area 15 or the user data stored in the data area 16. The head 21 also writes data into the disk 11. The head 21 may separately comprise a read element for reading data and a write element for writing data or, alternatively, may comprise integrated read element and write element. As the read element, a giant magnetic resistant (GMR) element which utilizes a giant magnetic resistant effect may by used. A plurality of heads 21 may be provided in accordance with the number of the disks 11. The head 21 is attached at one end of an arm 22, and moved in radial direction over the disk 11 by the arm 22.

A voice coil motor (VCM) 23 generates drive power for moving the head 21 attached to the arm 22 to a desired position. A coil is placed in a magnetic field made by a permanent magnet in the VCM 23 and a current is passed through the coil to generate the drive power. Magnitude of the drive power is proportional to the current passing through the coil of the VCM 23. The drive power generated by the VCM 23 is converted to rotational motion around a pivot 23 to move the head 21 rendering a circular locus. Therefore, in order to move the head 21 to a desired position, it is necessary to properly control the current applied to the VCM 23. The head 21 moves to a desired track by the drive power generated from the VCM 23, and writes or reads data to and from the desired track.

A signal read by the head 21 is demodulated by a signal processor 24 and subjected to error correction. When the head 21 reads servo data from the servo area 15, a position detector 25 detects a position signal from the read servo data to obtain the position of the head 21.

A controller 26 comprises a CPU 27 and a ROM 28 and executes various control processing including data write control, data read control, and a positioning control for the head 21. In the ROM 28, programs for the control processing and control parameters required for the control processing are prestored. The controller 26 may comprise a RAM (not shown) as a work memory. The RAM or the ROM 28 may be provided not inside the controller 26 but outside the controller 26.

When reading data written on the disk 11, and when writing data on the disk 11, it is required to accurately place a head 21 at a desired position over the disk 11. In accordance with the program and the control parameters stored in the ROM 28, the controller 26 executes positioning control for the head 21 over the disk 11. When controlling the positioning processing, the CPU 27 determines a control input value (value of the current to be supplied) for driving the VCM 23 based on the position of the head 21 detected by the position detector 25 and on a processing time measured by a timer which is not shown. The determined control input value is supplied to a VCM driver 29.

The VCM driver 29 controls the current passing through the VCM 23 under the instruction of the controller 26. Controlling the current that is driving through the VCM 23 allows the head 21 to move the desired position over the disk 11.

The disk 11 rotates at a constant angular speed, and a servo area 15 passes under the head 21 at constant time intervals. Therefore, the position signal read from the head 21 is observed by the position detector 25 at constant time intervals. Accordingly, an observation period (sampling period) of the position signal is constant. Thus, the controller 26 detects the current value to be supplied to the VCM 23 at the constant time intervals. That is, the controller 26 constitutes a sampled-data control system.

In the head positioning control system for the magnetic disk apparatus, a mechanical resonance may occur with the arm 22 and the VCM 23 which constitute a head driving mechanical system. A resonance of a higher order (higher-order resonance) than a lowest order resonance (main resonance) of the head driving mechanical system influences stability and head positioning accuracy in a high frequency band. Control performance of the control system depends on how to stabilize the resonance characteristics. Especially when the mechanical resonance frequency of the control target is higher than the Nyquist frequency, the control input may excite the mechanical resonance mode.

Hereinafter, description will be given on a feedback control system which maintains stability while suppressing excitation of the resonance using a resonance suppression filter, which suppresses a gain of a specific frequency, and a resonance filter, which increases a gain of a specific frequency.

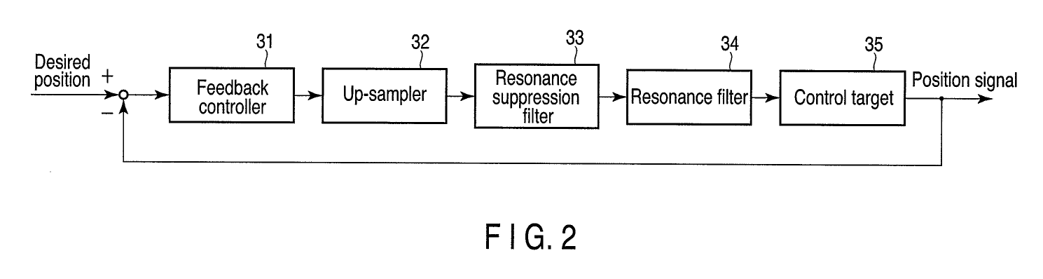

FIG. 2 is an exemplary block diagram of a multi-rate feedback control system, according to an embodiment of the invention.

In the control system, multi-rate feedback control is executed in such a manner that a control signal is supplied to the control target at a period which is 1/N (N is an integer equal to or larger than 2) of the sampling period of control output.

A feedback controller 31 operates at the same period as the observation period (sampling period) of the control output. Deviation that is a difference between a desired value and a control output value is input to the feedback controller 31

According to the magnetic disk apparatus of the present embodiment, the feedback controller 31 comprises the controller 26. An operation period of the feedback controller 31 is the same as the sampling period at which the position detector 25 detects the position signal from the head 21. In the present embodiment, the position error signal is input to the feedback controller 31 as the deviation. The position error signal is a difference between a desired position signal of the head 21 and the position signal of the head 21 detected by the position detector 25.

The feedback controller 31 outputs a control signal (control input) supplied to the control target 35. In the magnetic disk apparatus of the present embodiment, the position of the head 21 over the disk 11 is the control target. The position of the head 21 is controlled by an amount of the current passing through the VCM 23; therefore, the feedback controller 31 controls the current value to be supplied to the VCM 23. The current value is supplied to the VCM 23 via the VCM driver 29. The VCM driver 29 and the VCM 23 correspond an actuator of the control system according to the embodiment.

The feedback controller 31 may be any type of controller and is only required to control the current value inputting to the VCM 23 as the control signal. For example, the feedback controller 31 may be a PID controller which performs proportional control (P control), integral control (I control), and differential control (D control). The feedback controller 31 may include a controller which executes phase lead compensation or a differential compensation to stabilize the control target 35.

An output from the feedback controller 31 is input to an up-sampler 32. The up-sampler 32 converts the period of the control signal output from the feedback controller 31 to 1/N (N is an integer equal to or larger than 2) thereof. The up-sampler 32 executes compensation by zero-order hold where the same value is held for N steps.

The resonance suppression filter 33 performs gain compensation to prevent mechanical resonance occurring in the magnetic disk apparatus from inflicting damage on stability of the control system. The resonance suppression filter 33 operates at a period that is 1/N of the sampling period, and suppresses a gain at a specific frequency. In the present embodiment, the resonance suppression filter 33 suppresses a gain at a resonance frequency of a higher-order resonance occurring in mechanism of the magnetic disk apparatus. When the gain is suppressed at the resonance frequency by the resonance suppression filter 33, excitation of the resonance can be suppressed. As the suppression filter 33, a digital or analog notch filter may be employed.

Thus, excitation of a higher-order resonance can be restrained by reducing a gain at a higher-order resonance frequency by the resonance suppression filter 33. In such a case, main resonance characteristics may be stabilized by a phase lead compensator (or stabilizing filter) having a phase lead characteristic that is included in or connected to the controller 31, and not shown in the figure. When the mechanism of the magnetic disk apparatus has a plurality of resonant frequencies, the resonance suppression filter 33 may include a plurality of filters which are coupled in series, and each of which corresponds to each resonant frequency.

As described above, a conventional magnetic disk apparatus reduces a resonance frequency component from the control signal by applying the resonance suppression filter 33 to the output from the controller 31. Then, the control signal in which the frequency component of the resonance frequency is reduced is provided for the control target 35. Since the frequency component of the resonance frequency is eliminated from the control signal, excitation of the resonance is suppressed.

However, when the gain is reduced at the resonance frequency by the resonance suppression filter 33, phase delay may occur in a low frequency band and a phase margin of the control system may be decreased.

Consequently, in the present embodiment, a resonance filter 34 is connected to the resonance suppression filter 33 in series. In opposition to the resonance suppression filter 33, the resonance filter 34 increases a gain at a specific frequency. Especially when the gain is increased at the Nyquist frequency of the sampling frequency by the resonance filter 34, the phase can advance in the lower frequency band to improve the phase characteristic. In the present embodiment, the control signal output from the resonance filter 34 is supplied to the control target 35. As shown in FIG. 2, the resonance filter 34 is coupled subsequently to the resonance suppression filter 33; therefore, the resonance filter 34 operates at the same period as the resonance suppression filter 33 (1/N of the sampling period).

Hereinafter, improvement of the phase characteristic achieved by the resonance filter 34 will be described.

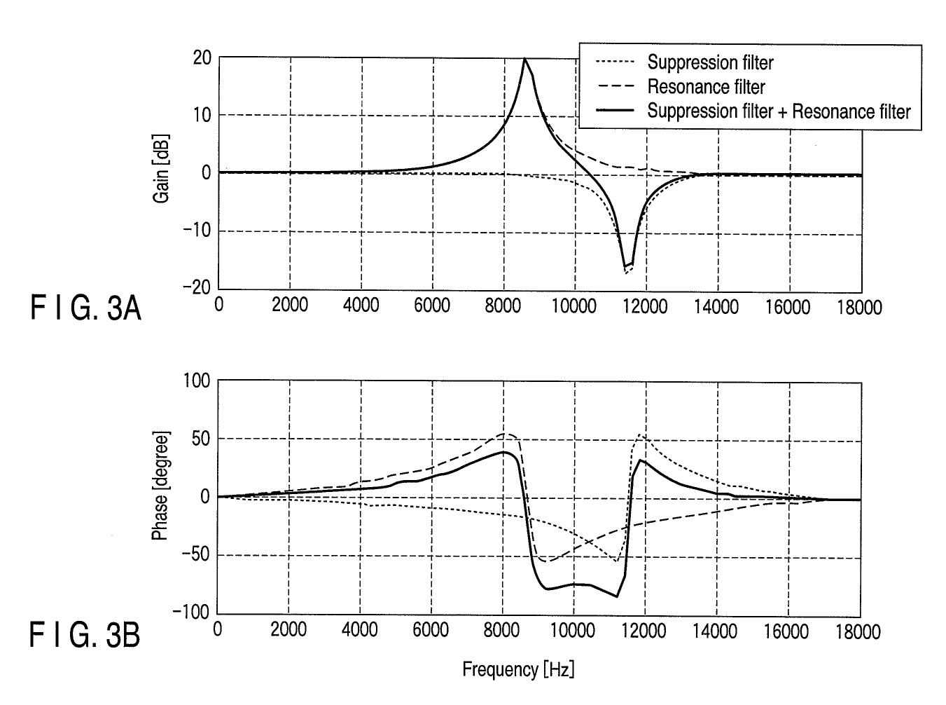

FIGS. 3A and 3B are exemplary Bode diagrams showing characteristics of the resonance suppression filter 33 and the resonance filter 34, according to the embodiment. FIGS. 3A and 3B show an example where “N=2” is set in the up-sampler 32, that is, the period of the control signal is set to half of the observation period of the position signal.

As shown in FIGS. 3A and 3B, the resonance suppression filter 33 suppresses a gain at a specific frequency, i.e., a frequency near the resonance frequency. Therefore, phase delay is generated in the low frequency band. That is, the phase characteristic is deteriorated in a low frequency band.

On the other hand, the resonance filter 34 increases a gain at a specific frequency, i.e., the Nyquist frequency that is determined from the observation period (sampling period) of the position signal from the head 21 observed by the position detector 25. Accordingly, as shown in FIGS. 3A and 3B, the phase advances in the low frequency band. That is, the phase characteristic in the low frequency band is improved.

Solid lines in FIGS. 3A and 3B represent characteristics for the case where the resonance suppression filter 33 and the resonance filter 34 are used in combination. As shown, the gain of the resonance frequency is suppressed; however, the phase is advanced in the low frequency band. Thus, the phase characteristic is improved.

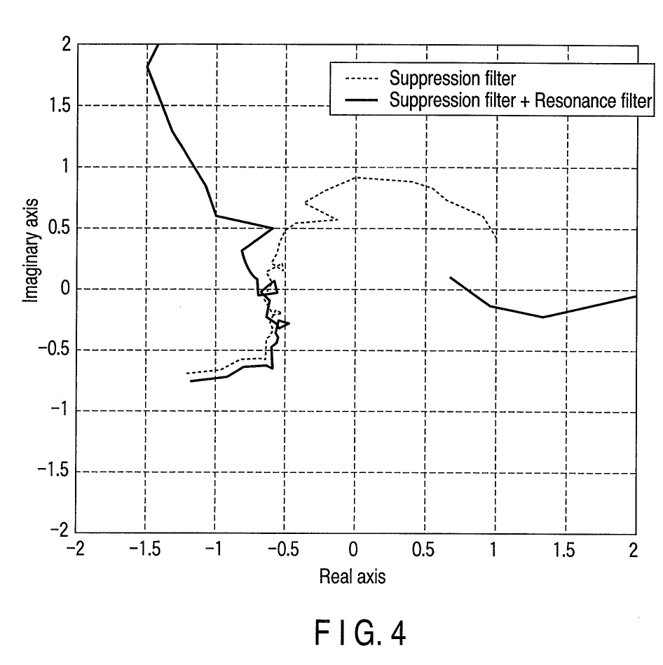

FIG. 4 is an exemplary Nyquist diagram of the multi-rate feedback control system, according to the present embodiment. A Nyquist diagram of a control system using only the resonance suppression filter 33 is indicated by a broken line, and a Nyquist diagram of a control system using both the resonance suppression filter 33 and the resonance filter 34 is indicated by solid lines. In comparison with the case where only the resonance suppression filter 33 is used, a right half-plane is widened in the case where the resonance suppression filter 33 and the resonance filter 34 are used in combination. This is because the gain is increased at the Nyquist frequency by the resonance filter 34. However, the Nyquist diagram of the control system using the resonance suppression filter 33 and the resonance filter 34 in combination does not rotate around a point (−1, 0), which is a remarkable point for the Nyquist stability criterion. Thus, even in such a case, stability of the control system is retained.

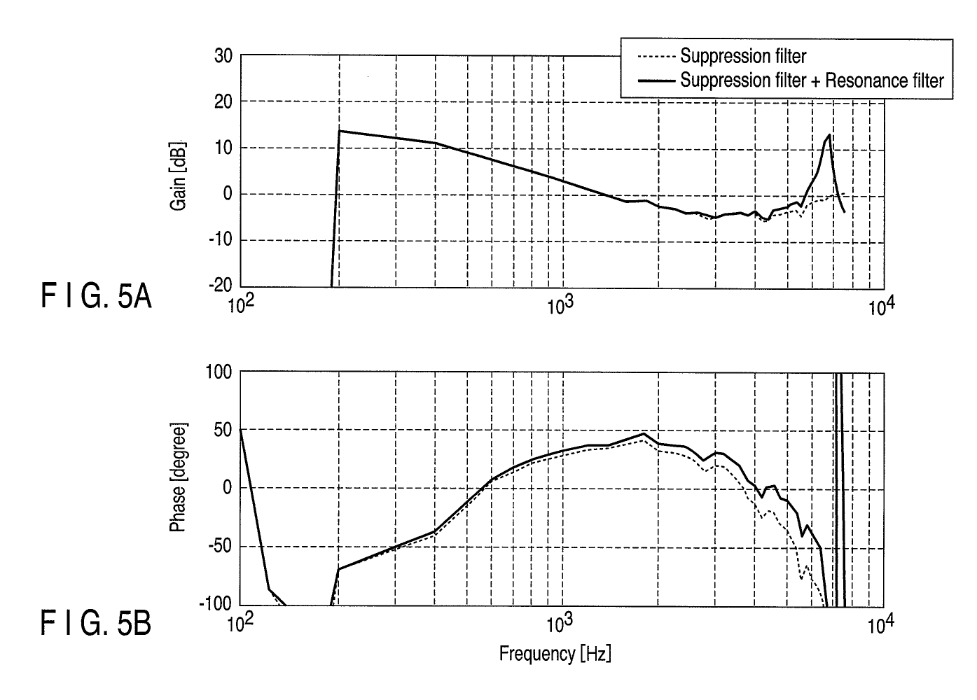

FIGS. 5A and 5B are exemplary views showing characteristics of open loop transfer functions in the multi-rate control system, according to the embodiment. Broken lines indicate an open loop transfer function of the control system for the case where only the resonance suppression filter 33 is used. Solid lines indicate an open loop transfer function of the control system for the case where both the resonance suppression filter 33 and the resonance filter 34 are used in combination.

As shown in FIGS. 5A and 5B, in the case where the resonance suppression filter 33 and the resonance filter 34 are used in combination, the gain is increased near the resonance frequency. However, the phase rotates significantly so that the stability is maintained.

In comparison with the case where only the resonance suppression filter 33 is used, the phase margin is improved in the case where both the resonance suppression filter 33 and the resonance filter 34 are used. Therefore, stability associated with the phase is improved in the case where the both filters 33 and 34 are used. The phase margin means a phase angle at a frequency where the gain is 0 dB, and represents how much change in the phase results in instability of the system.

The gain margin is also improved in the case where the resonance suppression filter 33 and the resonance filter 34 are used, in comparison with the case where only the resonance suppression filter 33 is used. Therefore, regarding the gain, performance is further improved in the case where the both filters 33 and 34 are used.

As described above, by using the resonance suppression filter 33 and the resonance filter 34 in combination, the phase characteristic in the low frequency band can be improved while suppressing the resonance of the control target. Specifically, increasing the gain at the Nyquist frequency allows maintaining stability of the feedback control system.

In the embodiment above, the resonance filter 34 only increases the gain at the Nyquist frequency of the sampling frequency; therefore, the configuration of the apparatus need not to be so complicated. Moreover, the above embodiment is applicable to any type of the feedback controller 31.

In the embodiment above, description is given on a case where the multi-rate feedback control system shown in FIG. 2 is applied to the head positioning control system for the magnetic disk apparatus by way of example. However, the multi-rate feedback control system shown in FIG. 2 may be applied to any control system other than the magnetic disk apparatus. For example, in a control system where a control target is observed by a plurality of different sensors, sampling periods of the sensors are different from each other. Such control system is essentially the multi-rate control system, and the control system shown in FIG. 2 can be applied to such control system.

In the embodiment above, description is given on the one-input one-output system, in which an amount of the current supplied to the VCM 23 is input as the control signal and the position error signal of the head 21 is observed as the control output, as an example of the control system shown in FIG. 2. However, the control system of FIG. 2 may be applied to multiple-input multiple-output control system. When single control input is utilized to control multiple outputs, merely the resonance suppression filter 33 and the resonance filter 34 may be applied to the single control input, similarly to the above embodiment. When multiple control inputs are provided, a set of the resonance suppression filter 33 and the resonance filter 34 may be applied to each of the control inputs.

In the description above, the gain is reduced at the resonant frequency of the high-order resonance by the resonance suppression filter 33. However, the resonance suppression filter 33 may reduce the gain at all the resonance frequencies.

The control system shown in FIG. 2 may be implemented as a part of another control system, or may include another control system therein.

As described above, in the present embodiment, a resonance filter having a resonance characteristic at the Nyquist frequency is added to a multi-rate feed back control system, thereby improving the phase characteristic of an open loop transfer function.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The various modules of the systems described herein can be implemented as software applications, hardware and/or software modules, or components on one or more computers, such as servers. While the various modules are illustrated separately, they may share some or all of the same underlying logic or code. The accompanying claims and their equivalents are intended to cover such forms or modifications as would fall within the scope and spirit of the inventions.

What is claimed is:

1. A head positioning control method for a magnetic disk apparatus, comprising:
suppressing a first frequency component of a control signal;
increasing a second frequency component of the control signal; and
moving the head to the desired position over the magnetic disk by an actuator based on the control signal.

2. The method of claim 1, wherein
the moving comprises moving the head to the desired position based on the control signal.

3. The method of claim 2, further comprising:
suppressing the first frequency component by a first filter configured to reduce a gain at the first frequency; and
increasing the second frequency component by a second filter configured to increase the gain at the second frequency.

4. The method of claim 2, further comprising:
reading a position signal from a surface of the magnetic disk in a first period by the head;
obtaining the control signal in the first period based on a difference between a desired position signal of the head and the read position signal; and
suppressing the first frequency component and increasing the second frequency component in a second period.

5. The method of claim 4, wherein the first frequency comprises a resonance frequency of the actuator and the second frequency comprises a Nyquist frequency of the first period.

6. The method of claim 4, further comprising changing a sampling period of the control signal by a sampler from the first period to the second period.

7. The method of claim 4, wherein the first period is an integral multiple of the second period.

8. A magnetic disk apparatus comprising:
a magnetic disk comprising a written position signal;
a head configured to read the position signal from the magnetic disk;
a filter configured to suppress a first frequency component and to increase a second frequency component of a control signal; and
an actuator configured to move the head to the desired position over the magnetic disk based on the control signal.

9. The apparatus of claim 8, wherein
the actuator is configured to move the head to the desired position based on a control signal comprising the first frequency component suppressed and the second frequency component increased.

10. The apparatus of claim 9, wherein
the filter is configured to reduce a gain at the first frequency and to increase the gain at the second frequency.

11. The apparatus of claim 9, wherein
the head is configured to read the position signal from the magnetic disk in a first period;
the controller is configured to calculate the control signal in the first period based on a difference between a desired position signal of the head and the read position signal; and
the filter is configured to operate in a second period.

12. The apparatus of claim 11, wherein the first frequency comprises a resonance frequency of the actuator and the second frequency comprises a Nyquist frequency of the first period.

13. The apparatus of claim 11 further comprising a sampler configured to change a sampling period of the control signal from the first period to the second period.

14. The apparatus of claim 11, wherein the first period is an integral multiple of the second period.

15. A feedback control method comprising:
suppressing a first frequency component of a control signal;
increasing a second frequency component; and
driving the control target by an actuator based on the control signal.

16. The method of claim 15, further comprising:
driving the control target based on a control signal comprising the first frequency component suppressed and the second frequency component increased.

17. The method of claim 16, further comprising:
suppressing the first frequency component by a first filtering configured to reduce a gain at the first frequency; and
increasing the second frequency component by a second filtering configured to increase the gain at the second frequency.

18. The method of claim 16, wherein
monitoring the control target in a first period;
obtaining the control signal in the first period; and
suppressing the first frequency component and increasing the second frequency component in a second period.

19. The method of claim 18, wherein the first frequency comprises a resonance frequency of the actuator and the second frequency comprises a Nyquist frequency of the first period.
